(19) United States
(12) Patent Application Publication
(10) Pub. No.: US 2026/0252621 A1
(43) Pub. Date: Aug. 27, 2026

(54) Identifying Content Formats Based On Search Query Intent

(71) Applicant: Google LLC, Mountain View, CA (US)

(72) Inventor: Zhaolong Yu

(21) Appl. No.: 18/863,857

(22) PCT Filed: Nov. 28, 2023
(86) PCT No.: PCT/US2023/081355

§ 371 Date: Nov. 7, 2024

(51) Int. Cl. G06F 16/435; G06N 3/08

(52) U.S. Cl. CPC G06F 16/435; G06N 3/08

(57) ABSTRACT

The technology is generally directed identifying content responsive to a search query having a format corresponding to a determined query intent. The format may be, for example, images, videos, text, audio, or a combination of these formats. The query intent may indicate a given format for the responsive content. The query intent may correspond to an intent index value, which indicates the likelihood that the search query is for content having a given format. The intent index value may be determined using an algorithm, such as a ratio or an artificial intelligence model. The intent index value may be used to identify the content responsive to the search query.

### BACKGROUND

Users typically search for content by submitting a search query to a search engine, website, or mobile application. The search may search for responsive content in all formats. Search results, including content related to the search query, are identified and returned to the user. The different formats of content are typically provided for output to the user under different tabs or filters. Therefore, the format of the content in the search results may not be in the format the user was expecting. For instance, a user may submit a search query expecting the content of the search results to be images, but instead, the content of the search results may be text or video. To view the image search results, the user typically has to select another tab or filter on the search results. This can be frustrating and time consuming, as the user may have to submit additional search queries, apply search filters, or the like to obtain search results in a given format.

### BRIEF SUMMARY

The technology is generally directed to identifying content responsive to a search query having an output format corresponding to a determined query intent. The format may be, for example, images, videos, text, audio, or a combination of these formats. The query intent may indicate a format for the content responsive to the search query. The query intent may correspond to an intent index value, which indicates the likelihood that the search query is for content having a given format. The intent index value may be determined using an algorithm, such as a ratio or an artificial intelligence model. The intent index value may be used to identify the content responsive to the search query. In some examples, the search query may be mapped to a cluster associated with one or more intent index values. The cluster may include content responsive to the search query in the format corresponding to the query intent. In other examples, the intent index value may be provided as input to an AI model that is trained to identify content responsive to the search query in the format corresponding to the query intent.

One aspect of the technology is directed to a method, comprising: receiving, by one or more processors, a search query, identifying, by the one or more processors based on the search query, a discrete cluster of a plurality of clusters, wherein each cluster of the plurality of clusters includes content in a respective format, determining, by the one or more processors based on the discrete cluster, an intent index value, wherein the intent index value provides an indication that the search query is for content in a first format, identifying, by the one or more processors based the intent index value, content responsive to the search query, and providing for output, by the one or more processors, the identified content in a second format corresponding to the first format.

When identifying the discrete cluster, the method may further comprise comparing, by the one or more processors, at least one term within the search query to terms within the plurality of clusters and identifying, by the one or more processors, the discrete cluster having search queries corresponding to the at least one term

Each of the plurality of clusters may be equal in size based on a number of historical queries. Each respective cluster may correspond to a range of intent index values or the intent index value. The content may include at least one digital component.

When determining the intent index value, the method may further comprise providing, by the one or more processors, the search query as input into artificial intelligence (“AI”) model, and determining, by the one or more processors executing the AI model, the intent index value. The method may further comprise training the AI model. Training the AI model may comprise associating labels with search queries, wherein the labels indicate a search filter associated with the search queries and providing, as training data, one or more query level features. The query level features may comprise one or more of historical properties of the search queries, embeddings associated with the search queries, query string features, geographical features associated with the search queries, or language of the search queries. The AI model may be a language model (LM) or a large language model (LLM).

Determining the intent index value may comprise determining a ratio of a number of search queries for the first format to a total number of search queries for all formats.

The first format may include one or more of image, video, text, or audio. The second format may include one or more of image, video, text, or audio.

The method may further comprise providing as input, by the one or more processors, the respective cluster to an artificial intelligence (AI) model. The method may further comprise determining, by one or more processors executing the AI model, the second format of the content, wherein the second format of the content includes one or more of a size and the format of the content. The method may further comprise adjusting, by the one or more processors executing the AI model, a click through rate (CTR) prediction. Adjusting the CTR prediction may include up-regulating the CTR prediction when the identified discrete cluster has a range of intent indexes above a threshold, and down-regulating the CTR prediction when the identified discrete cluster has a range of intent indexes below the threshold.

The content may include at least one digital component.

Another aspect of the technology is directed to a system comprising one or more processors. The one or more processors may be configured to receive a search query, determine, based on the search query, an intent index value, wherein the intent index value provides an indication that the search query is for content in a first format, identify, based on the intent index value, a discrete cluster of a plurality of clusters, wherein each cluster of the plurality of clusters includes content in a respective format, identify, based the discrete cluster, content responsive to the search query, and provide for output the identified content in a second format corresponding to the first format.

Yet another aspect of the technology is directed to one or more computer readable media encoding instructions that, when executed by one or more processors, cause the one or more processors to perform operations comprising receiving a search query, determining, based on the search query, an intent index value, wherein the intent index value provides an indication that the search query is for content in a first format, identifying, based on the intent index value, a discrete cluster of a plurality of clusters, wherein each cluster of the plurality of clusters includes content in a respective format, identifying, based the discrete cluster, content responsive to the search query; and providing for output the identified content in a second format corresponding to the first format.

Another aspect of the technology is directed to a method, comprising receiving, by one or more processors, a search query, determining, by the one or more processors based on the search query, an intent index value, wherein the intent index value provides an indication that the search query is for content in a first format, identifying, by the one or more processors based the intent index value, content responsive to the search query, and providing for output, by the one or more processors, the identified content in a second format corresponding to the first format.

### BRIEF DESCRIPTION OF THE DRAWINGS

FIG. 1 is a screenshot illustrating example content responsive to a search query in a format corresponding to the query intent according to aspects of the disclosure.

FIG. 2 is an example sequence diagram of steps illustrating steps for providing content responsive to a search query according to aspects of the disclosure.

FIG. 3A is a flow diagram of an example method of training an intent index model according to aspects of the disclosure.

FIG. 3B is a flow diagram of an example method of executing the intent index model according to aspects of the disclosure.

FIG. 4 is an example of mapping clusters and intent index value ranges according to aspects of the disclosure.

FIG. 5A is a flow diagram of an example method of training a content identification model according to aspects of the disclosure.

FIG. 5B is a flow diagram of an example method of executing the content identification model according to aspects of the disclosure.

FIG. 6 is a block diagram of an example system according to aspects of the disclosure.

FIG. 7 is a flow diagram for an example method of determining content responsive to a search query having a format corresponding to a query intent according to aspects of the disclosure.

FIG. 8 is a flow diagram for another example method of determining content responsive to a search query having a format corresponding to a query intent according to aspects of the disclosure.

### DETAILED DESCRIPTION

The technology generally relates to determining content to return in response to a search query based on a determined query intent. The content may be formatted as images, videos, text, audio, or a combination of these formats. The search query may be mapped to a cluster. For example, the search query may be mapped to the cluster based on the similarity of the search query as compared to the historical search queries allocated to the cluster. The cluster may be a discrete cluster of a plurality of clusters. The discrete cluster may be associated with one or more intent index values. The intent index value may correspond to the likelihood that the search is for content having a certain format. In some examples, the intent index value may be referred to as a confidence value corresponding to the confidence that the search query is for content having the certain format. According to some examples, the intent index value may correspond to a query intent. The query intent may, for example, indicate a given format for content in response to the search query. The intent index values may be mapped to content in a given format. The content associated with the intent index values and/or clusters may be responsive to the search query.

According to some examples, the cluster may include content in the format corresponding to the query intent. Based on the intent index value associated with the mapped, content responsive to the search query may be identified. The content responsive to the search query may be provided in the format corresponding to the query intent.

The content may include at least one digital component. The content and/or digital component may be of the format corresponding to the query intent. For example, if the query intent was highly likely for images, the content and/or digital component provided for output may include one or more images.

Providing content in a format corresponding to the intent of the search query may increase the computational efficiency of the system. For example, if the system determines that the intent of a search having a particular search query is to receive content in the format of images, the number of inputs received by the system may decrease. In this regard, a user may no longer have to separately and/or additionally search for content in a format corresponding to the intent of the search. The decrease in inputs, such as separate and additional searches, may decrease the amount of processing and network overhead required to provide content.

As an example, if a user submits a web search, including a search query for “dogs running through the field,” the system may determine, based on the intent index, that the intent of the user submitting the search query was to receive images showing “dogs running through the field.” By providing content in the format of images responsive to the search query, e.g., “dogs running through the field,” the system does not have to receive an input switching from web search to image search, nor does the system have to receive a secondary search query for “image of dogs running through the field.”

Reducing the number of inputs and/or searches for content in a format corresponding to the intent of the search reduces the number of inputs, processing power, and network overhead to access the content. Further, reducing the number of searches or inputs required by a user to identify and/or provide the content in a format responsive to the search query intent decreases the number of client device and server interactions to obtain the same information as automatically providing content in a format corresponding to the intent of the search query. This, too, decreases the processing power and network overhead and increases the computational efficiency to provide content responsive to the search query.

Mapping the search queries to a given cluster based on the similarity of the search query to historical search queries allocated to the cluster may increase the computational efficiency of the system. For example, rather than using semantic proximity to identify similar historical search queries and the associated intent, e.g., the cluster, the system may compare terms of the search query to terms of historical search queries to identify similarities. After identifying the most similar historical search queries to the new search query, the system may identify the discrete cluster to map the new search query to. This increases computational efficiency as compared to identifying the cluster based on semantic proximity as using semantic proximity is complicated and computationally intensive due to the extreme volume of historical search queries. Having to determine the semantic proximity of the new search query to the extreme volume of historical search query would result in an increased use of computational resources, e.g., memory, processing power, and network overhead, and would not result in a quick and efficient identification of a cluster. Using semantic proximity to identify the cluster would then delay the identification of content responsive to the search query. Accordingly, by mapping the new search query to a given cluster based on similarities to historical search queries, the system is more efficient by using less computational resources, e.g., memory, processing power, and network overhead.

According to some examples, mapping the search query to a cluster associated with an intent index value avoids a heavy semantic approach, e.g., semantic proximity, or a large language model (“LLM”) approach that may, in some examples, be more precise but at the detriment of the time it takes to process the search query and provide responsive content. The use of clusters associated with an intent index value simplifies the determination of the query intent, while being both computationally efficient and effective in providing responsive content in the format corresponding to the query intent.

In some implementations, the techniques disclosed herein enable techniques for enabling artificial intelligence to determine responsive content to a search query based on a determined query intent. Artificial intelligence (AI) is a segment of computer science that focuses on the creation of models that can perform tasks autonomously with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing, understanding, and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

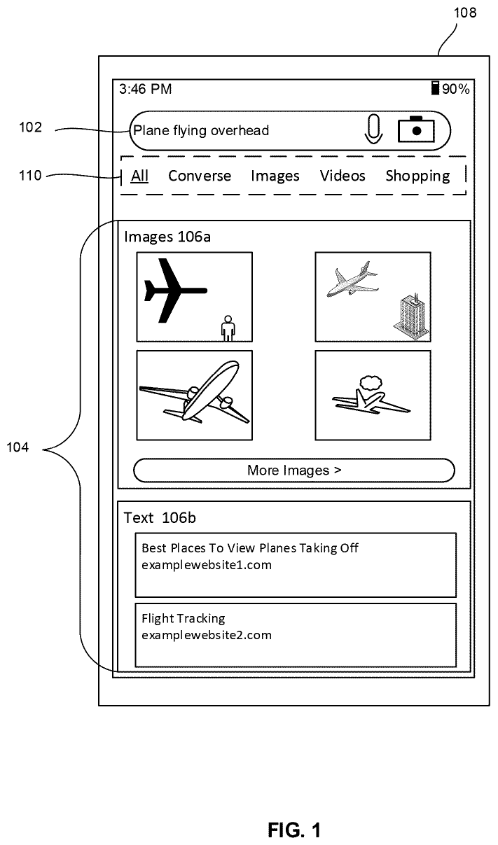

FIG. 1 is an example output of search results in response to a search query. For example, a publisher may receive a search query 102 for “plane flying overhead.” The publisher may be, for example, a search engine, retailer, or any online entity providing content for output to a user via a website or mobile application. In response to the search query 102, the publisher may provide content 104 for output on a display of a user device 108. The content 104 may be responsive to the search query 102 and in a format corresponding to a determined query intent. The query intent may, for example, indicate a given format for the responsive content 104. For example, the query intent may be to receive images, videos, shopping links, or the like responsive to the search query 102.

The query intent may be determined based on an intent index value associated with the search query 102. The intent index value may provide a likelihood that the search query is for content having a certain format, e.g., images, videos, text, shopping links, or the like. In some examples, the intent index value may correspond to a confidence value and/or query intent for the search query being for content in the certain format. The intent index value may be determined using one or more algorithms.

In some examples, the algorithm is a ratio of the number of search queries for a search filter 110 as compared to the total number of search queries. The search filters 110 may include, for example, “all”, “converse”, “images”, “videos”, “shopping”, “web”, “news”, “maps”, “books”, “flights”, “finance”, etc. The ratio for the intent index value may, therefore, be the ratio of the search query having a certain search filter 110 as compared to the total number of search queries, regardless of the search filter 110.

As some examples, the search filter ‘all” may correspond to a selection of all available search filters 110. Search filter 110 “images” may result in filtering the search results, or content responsive to the search query, to include primarily images responsive to the search query 102. Search filter 110 “videos” may result in filtering the search results to include, primarily, videos responsive to the search query 102. Search filter 110 “shopping” may result in filtering the search results to include, primarily, digital content corresponding to products or services available for purchase. Search filter 110 “web” may result in filtering the search results to include, primarily, digital content having text and/or graphics responsive to the search query 102.

In some examples, the algorithm may be an artificial intelligence (“AI”) model that has been trained to predict the intent index value for the search query 102. The AI model may be an intent index model that is trained based on training labels indicating whether a historical search query used a certain search filter 110. The training data may include, for example, search histories. The intent index model may predict the intent index value by mapping the search query 102 to a likelihood that the search query 102 is for a given format of content, e.g., images, text, videos, etc.

According to some examples, the intent index value may be used to identify content 104 responsive to the search query 102. In one example, the intent index value may correspond to a cluster that is mapped to a query intent. Content 104 responsive to the search query 102 may be identified from the cluster. For example, the content within the cluster may be in the format corresponding to the format indicated by the query intent. For example, if the intent of the user submitting the search query 102 was to receive images responsive to the search query, the responsive content 104 may include one or more images 106a. In some examples, content in a related format may also be provided as responsive content 104. For example, if the intent of the user submitting the search query 102 was to receive images 106a, related content may include text 106b. The content 104 in the format corresponding to the query intent, e.g., images 106a, may be provided for output in a more prominent location as compared to content in a related format, e.g., text 106b.

In some examples, the intent index value may be provided to a decision making or content identification model that consists of many AI model signals. The AI model signals may be, in some examples, ML model signals. The intent index value provided as input into the content identification model may be used to change, alter, and/or adjust the decision of the content identification model. Changing the decision of the content identification model may lead to identifying responsive content.

In another example, the intent index value may be provided to an AI model, such as a content identification model. The content identification model may be, in some examples, a ML model. The intent index value may be provided as a weight, or signal, into the content identification model. The content identification model may be trained to predict the format of content that satisfies the search query and identify content having the predicted format. The identified content having the predicted format may be provided for output as responsive content 104.

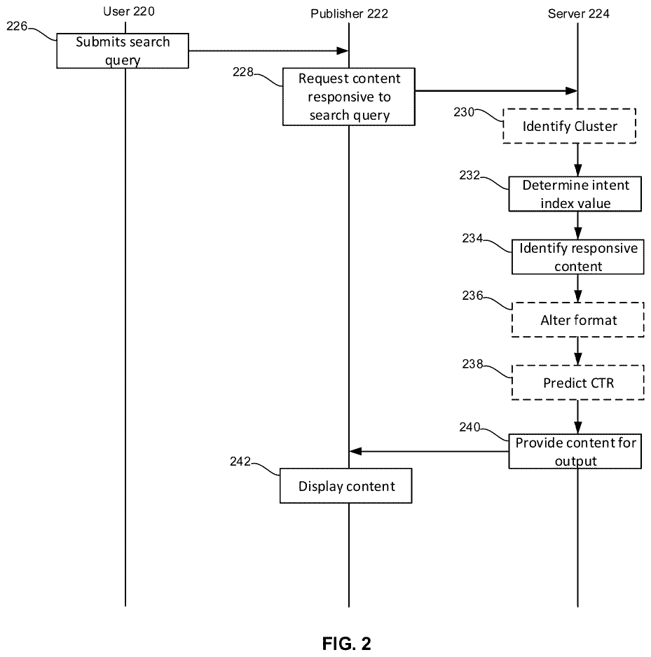

FIG. 2 is an example sequence diagram of steps that may occur among a user, a publisher, and a server. The following operations do not have to be performed in the same order described below. Rather, various operations can be handled in a different order or simultaneously, and operations may be added or omitted. For example, operations shown with dashed lines may be optional and, therefore, may be performed in some examples but not others.

In block 226, a user 220 may submit a search query to a publisher 222. For example, the publisher 222 may be a search engine, retailer, or the like. The search query may be, for example, “plane flying overhead.” When submitting the search query, the user may have a query intent associated with the search query. The query intent may be, for example, the intended format of content responsive to the search query. For example, the user 220 may have the intent to receive responsive content in a given format. The given format may be, for example, images, videos, text, or the like.

In block 228, in response to receiving the search query, the publisher 222 may transmit a request to a server 224 for content responsive to the search query. The server 224 may be configured to identify the query intent of the search query received by the publisher 222 and identify content responsive to the search query in the format corresponding to the query intent.

In block 232, the server 224 may determine the intent index value. The intent index value may provide a likelihood that the search query is for content having a certain format. For example, the intent index value may provide a likelihood that the search query, e.g., “plane flying overhead,” is a query for an image of a plane flying overhead, instead of a web search, shopping search, news search, etc. Other formats of content, besides images, may include, for example, text, video, audio, etc. In some examples, the intent index value may be a confidence value for the search query being for content in the certain format. Additionally or alternatively, the intent index value may correspond to the query intent for the search query being for content in the certain format.

In some examples, the intent index value for a newly received search query may be determined as a ratio. The ratio may be the number of search queries for a first search filter as compared to the total number of search queries. For example, the search engine may include a plurality of search filters such as, web search, image search, shopping search, news search, or the like. As one example, if the search query includes a search filter for an image search, the ratio may be the number of search queries including the search filter for an image search as compared to the total number of search queries for all search filters, e.g., search queries for images, web searches, shopping searches, new searches, etc. The ratio may correspond to the intent index value.

Continuing with the example, the search query for “plane flying overhead” may be received as a web search, image search, etc. Based on the filter for the search query, the intent index value for the search query “plane flying overhead” may be determined. The intent index value for the search query “plane flying overhead” may be the ratio of the search queries using the search filter for “plane flying overhead” as compared to the total number of search queries. The search filter may be, for example, all, converse, images, videos, shopping, web, news, maps, books, flights, finance, etc.

In some examples, the intent index value may be determined using AI, such as a large language model (“LLM”). The AI may be trained to provide, as output, the intent index value. The AI may be trained based on training labels indicating whether a historical search query used a certain search filter, such as an image search, a web search, or the like. The training data may include, for example, search histories. The search history may include query level features. The features may include, for example, properties associated with historical search queries, embeddings associated with historical search queries, historical search query string features, geographical information associated with historical search queries, the language of the historical search query, or the like. The query level features may be provided as input to the AI model and the intent labels may be provided as output. The model may be trained and tuned to update the parameters of the model.

The AI may be trained to predict the intent index value. For example, the AI may map the words in the search query to a likelihood that the search query is for a given format of content. Based on the mapping, the AI may provide an output, e.g., the intent index value, corresponding to the likelihood the search query is seeking a given format of content in response. The intent index value may, in some examples, correspond to the query intent. According to some examples, a higher intent index value may correspond to a greater likelihood that the search query was for a given format of content. A lower intent index value may correspond to a lesser likelihood that the search query was for the given format of content.

Continuing with the above example, if the received search query was “plane flying overhead,” the intent index value determined by the AI may indicate a high likelihood that the content responsive to the search query should have an image format. In contrast, if the received search query was for “gas stations near me,” the intent index value determined by the AI may indicate a low likelihood that the content responsive to the search query should have an image format.

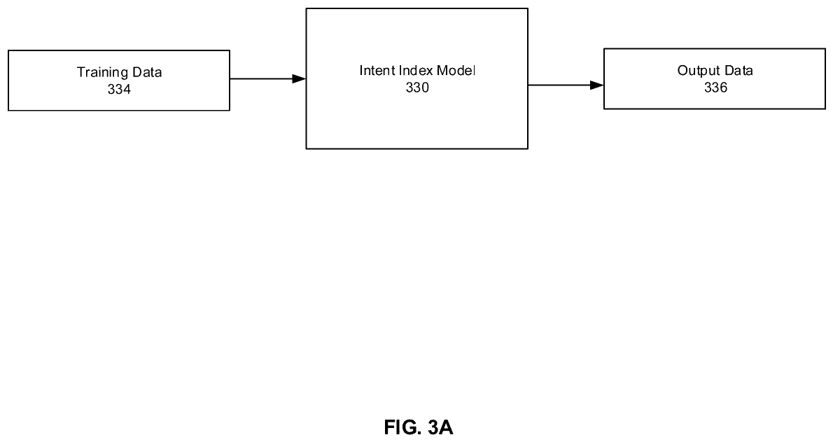

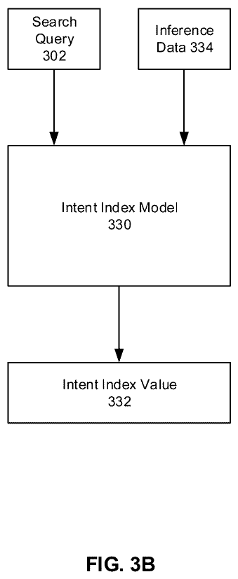

FIG. 3A depicts a block diagram of an example flow diagram for training an intent index model 330 which can be implemented on one or more computing devices. The intent index model 330 can be configured to receive training data 334 for use in predicting the query intent of a search query received by a publisher. The predicted query intent may be output in the form of an intent index value, confidence value, query intent, intent label, or the like. For example, the intent index model 330 can receive the training data 334 as part of a call to an application programming interface (API) exposing the intent index model 330 to one or more computing devices. Training data 334 can also be provided to the intent index model 330 through a storage medium, such as remote storage connected to the one or more computing devices over a network. Training data 334 can further be provided as input through a user interface on a client computing device coupled to the intent index model 330.

The training data 334 can correspond to an AI task for predicting the query intent of a search query received by the publisher. The AI task may be, for example, a ML task, such as a task performed by a neural network. The training data 334 can be split into a training set, a validation set, and/or a testing set. An example training/validation/testing split can be an 80/10/10 split, although any other split may be possible. The training data 334 can include examples for predicting the query intent of a search query received by the publisher. The training data 334 may include query level features associated with historical searches. The query level features may include properties associated with historical search queries, embeddings associated with historical search queries, historical search query string features, geographical information associated with historical search queries, the language of the historical search query, or the like. In some examples the query level features 334 may be paired with training labels indicating whether the query level feature is associated with a certain format of content.

The training data 334 can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, if the AI task is a classification task, the training examples can be images labeled with one or more classes categorizing subjects depicted in the images. As another example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the training data 334, the intent index model 330 can be trained to predict the query intent of a search query received by the publisher. According to some examples, the intent index model 330 may provide, as output, one or more results related to the prediction. The results of the intent index model 330 may be generated as output data 336. As examples, the output data 336 can be any kind of score, classification, or regression output based on the input data. Correspondingly, the AI task can be a scoring, classification, and/or regression task for predicting some output given some input. The input may be, for example, query level features and the output 336 may be, for example, intent labels. The intent labels may be associated with a query intent. In some examples, the intent labels may be associated with an intent index value corresponding to the query intent. These AI tasks can correspond to a variety of different applications in processing images, video, text, speech, or other types of data to predicting the query intent of a search query received by the publisher. The output data 336 can include instructions associated with predicting the query intent of a search query received by the publisher.

As an example, the intent index model 330 can be configured to send the output data 336 for display on a client or user display. As another example, the intent index model 330 can be configured to provide the output data 336 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The intent index model 330 can further be configured to forward the output data to one or more other devices configured for translating the output data into an executable program written in a computer programming language. The intent index model 330 can also be configured to send the output data to a storage device for storage and later retrieval.

FIG. 3B is a flow diagram illustrating the execution of the intent index model 330. When executed, the search query 302 received by the publisher may be provided as input into the intent index model 330. According to some examples, inference data 332 may be provided as input into the intent index model 330. The intent index model 330 can receive the inference data 332 as part of a call to an API exposing the intent index model 330 to one or more computing devices. Inference data 332 can also be provided to the intent index model 330 through a storage medium, such as remote storage connected to the one or more computing devices over a network. Inference data 332 can further be provided as input through a user interface on a client computing device coupled to the intent index model 330.

The inference data 332 can include data associated with predicting the query intent of a search query received by the publisher. The inference data 332 may include training labels associated with historical search queries. The training labels may indicate whether the historical search query used a certain search filter, such as an image search, a web search, or the like.

From the inference data 332 and/or the search query 302, the intent index model 330 may predict the query intent of the search query 302. For example, the intent index model 330 may map the words in the search query 302 to a likelihood that the search query is for a given format of content. The likelihood that the search query is for a given format of content may correspond to an intent index value. The intent index model 330 may provide, as output, the intent index value 332.

Referring back to FIG. 2, in block 234, the server may identify content responsive to the search query. For example, the intent index value may be used to determine a format for content responsive to the search query. For example, the intent index value may provide an indication of the query intent and, therefore, the format. In some examples, the intent index value may correspond to a weight or signal provided as input into an AI model, such as a ML model. The weight may correspond to how likely or not likely the query intent is for content having a particular format. In some examples, the intent index value provided as input into the AI model may be one of a plurality of signals provided to the AI model. The intent index value may be used to change the decision of the AI model, e.g., the content identification model. Changing the decision of the AI model may lead to identifying responsive content.

According to some examples, the AI model may be trained, amongst other things, to predict the format of content that satisfies the search query. In some examples, the AI model may be trained to identify content responsive to the query in the format that satisfies the search query.

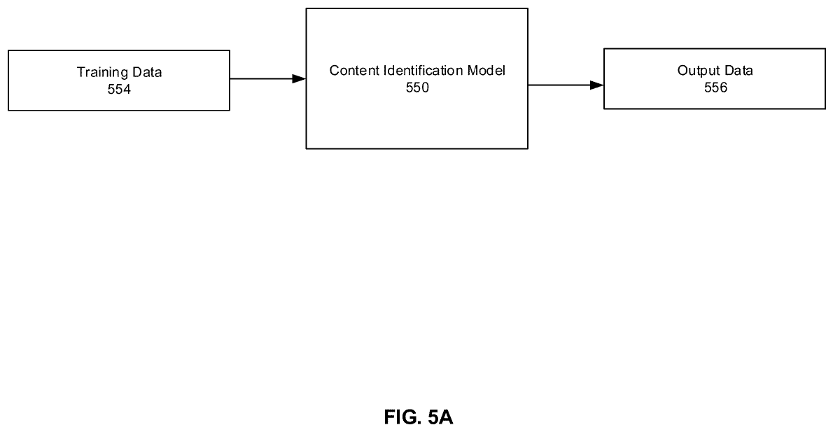

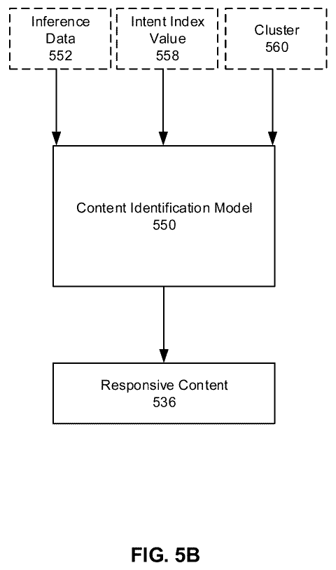

FIG. 5A depicts a block diagram of an example flow diagram for training content identification model 550 which can be implemented on one or more computing devices. The content identification model 550 can be configured to receive training data 334 for use in predicting the format of content that satisfies the search query. In some examples, the content identification model 550 may be trained to identify content responsive to the query in the format that satisfies the search query.

The content identification model 550 may receive and/or process the training data 554 in methods similar to those described above with respect to the intent index model 330. The content identification model 550 may provide, as output, one or more results related to the prediction. The results of the content identification model 550 may be generated as output data.

The training data 554 can correspond to an AI task for predicting the format of the content that satisfies the search and/or predicting content in the format that satisfies the search query.

From the training data 556, the content identification model 550 can be modified, or trained, to identify content responsive to the search query in a format corresponding to the query intent. According to some examples, the content identification model 550 may provide, as output, one or more results related to the identification. The results of the content identification model 550 may be generated as output data 226. In some examples, the output data 536 may be content associated with a given intent index value and/or cluster. The output data 536 may be content responsive to the search query in the format corresponding to the query intent. The content identification model 550 may be configured to send, provide, etc., the output data 536 similarly to intent index model 330. For example, the content identification model 550 may be configured to send the output data 536 to a publisher such that the publisher may provide the output data 536 for display on a client or user display. In some examples, the content identification model 550 may be configured to send the output data 536 for display on a client or user display.

FIG. 5B is flow diagram illustrating the execution of the content identification model 550. When executed, the intent index value 558 may be provided as input into the content identification model 550. For example, if only the intent index value 558 is determined, then the intent index value 558 is provided as input into the content identification model 550. In examples where the search query is mapped to a cluster 560, then the intent index value 558 associated with the cluster 560 and/or the cluster 560 may be provided as input into the content identification model.

According to some examples, inference data 552 may be provided as input into the content identification model 550. The content identification model 550 may receive and/or process the inference data 552 in methods similar to those described above with respect to the intent index model 330.

The inference data 552 for the content identification model 550 can include data associated with predicting the format of the content that satisfies the search and/or predicting content in the format that satisfies the search. The inference data 552 may include training labels associated with historical search queries. The training labels may indicate a format of content responsive to the historical search query.

The content identification model 550 may use the intent index value 558 to identify content responsive to the search query in a format associated with the intent index value 558 and/or cluster 560. The content identification model 550 may provide, as output, the responsive content 536.

According to some examples, the content responsive to the search query may include, for example, digital components. The digital components may be advertisements. For example, in response to receiving a search query, the publisher may transmit a request to the server for content responsive to the search query, including one or more digital components to be displayed relative to the search results. The digital components may, in some examples, be related to and/or associated with the search query such that the digital components are responsive to the search query. For example, if the search query is “plane flying overhead”, the digital components may be for related goods and services, such as fights, toy airplanes, or the like. In examples where the responsive content includes digital components, the content identification model 550 may be trained to predict and/or identify one or more digital components responsive, related to, and/or associated with the search query in a format corresponding to the query intent of the search query. For example, if the search is for “plane flying overhead”, the query intent may be images to be provided as responsive content. The digital components identified by the content identification model 550 may be image based digital components, as compared to audio, text, or video based digital components.

Referring back to FIG. 2, in block 240, the server 224 may provide the responsive content to the publisher 22. For example, the server 224 may transmit the responsive content to the publisher 222.

In block 242, the publisher 222 may provide the responsive content for display. For example, the publisher 22 may output the responsive content for display on the display of a client or user device. The responsive content may be in a format corresponding to the query intent. For example, the intent index value determined in block 232 may provide an indication that the search query is for content in a certain format, such as images. The responsive content may be content in a format corresponding to the format indicated by the intent index value, e.g., images. By providing content in the format matching the intent of the search query, e.g., by providing images when the intent of the search query is to receive images, the computational efficiency of the system increases. For example, a user no longer has to separately and/or additionally search for content in the intended format. This decreases the number of inputs received by the system, such as by having to perform separate and/or additional searches or by having to apply various search filters. Reducing the number of inputs decreases the amount of processing and network overhead required to provide responsive content.

In some examples, rather than and/or in addition to using an AI model to determine the intent index value, the search query 226 may be used to identify a cluster. For example, in block 230, a cluster may be identified. The cluster may be identified based on the search query. For example, the search query may include one or more search terms. The search terms may be compared to historical search queries that have been previously mapped and/or associated with a cluster. In some examples, the search query may be mapped to the cluster having historical search queries corresponding to at least one search term. In another example, the search query may be mapped to the cluster having substantially similar search queries. For example, if the search query is for dogs running through a field, the search query may be mapped to the cluster having historical searches such as “dogs running”, “dog in field”, or “running with dogs.” Mapping the incoming search query 226 to the cluster having historical search queries that are substantially similar to the incoming search query 226 may increase the computational efficiency of the system. For example, an alternative to identifying the cluster would for the system to identify historical search queries that are within semantic proximity of the incoming search query 226. However, determining the semantic proximity of the incoming search query 226 to the extreme volume of historical search queries would require large amounts of processing power and network overhead due to the millions and billions of historical search queries. Further, using semantic proximity would not result in obtaining a fast and efficient determining of a cluster that is then used to identify responsive content. Accordingly, using semantic proximity would not allow for responsive content to be provided substantially instantaneously as it would take too long and require too much processing power to identify the cluster. The inefficiency of semantic proximity is resolved by mapping the incoming search query to a cluster based on the similarities of the incoming search query to historical search queries. While the comparison may be done by processors of the system, the comparison and/or mapping of the incoming search query may be performed by an AI model.

The cluster identified in block 230 may be used to determine an intent index value. For example, the cluster identified in block 230 may be associated with an intent index value that is mapped to a query intent. The query intent may provide an indication as to a format of content responsive to the search query. According to some examples, the cluster may have a range of intent indexes inclusive of the determined intent index. The size of the ranges of intent indexes for the clusters of the plurality of clusters may be different, the same, or a combination. For example, a first cluster may have a range of 0.00-0.07, a second cluster may have a range of 0.08-0.15, a third cluster may have a range of 0.16-0.26, and so on. In such an example, the size of the range of the first and second clusters may be the same, while the size of the range of the third cluster may be different from the first and second clusters.

The intent index values may be determined based on the total number of historical searches allocated to the plurality of clusters. For example, historical search queries may be separated equally into a plurality of clusters such that each cluster includes substantially the same number of historical search queries. The historical search queries may be separated into the clusters based on their respective intent index.

According to some examples, the intent index value(s) associated with a given cluster may be determined offline or in the background, separate from determining the query intent. For example, the intent index value associated with a given cluster may be determined before receiving a new search query. The intent index values may, in some examples, be continuously updated as new search queries are received. This may allow for the intent index values associated with the clusters to be up to date based on the large volume of search queries.

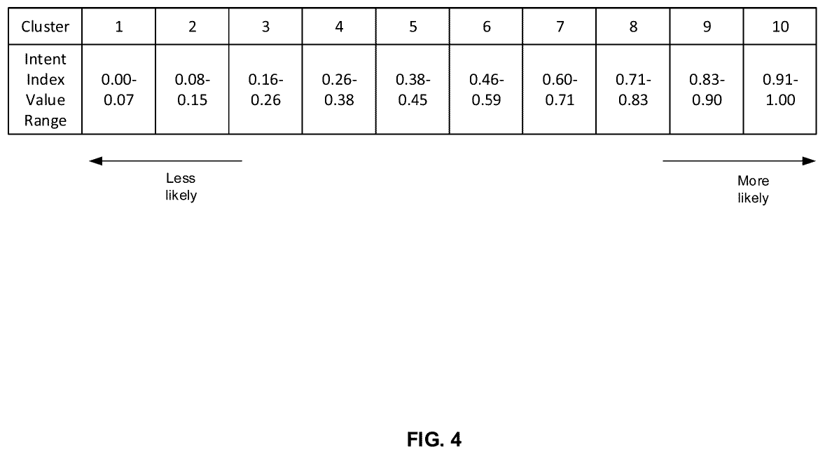

FIG. 4 illustrates an example of clusters and associated intent index value ranges. In some examples, the intent index may be based on a scale of 0-1, 0-100, 0-5, etc. As shown, the intent index values, ranging from 0-1, may be divided amongst a number of clusters. In the example shown in FIG. 4, the intent index values are split amongst ten clusters. However, there may be any number of clusters, such as five, seven, twenty, 100, etc. such that the example of ten clusters, as shown, is just one example and is not intended to be limiting.

The intent index value ranges for each cluster may be determined based on the number of historical search queries and their respective intent index values. In some examples, rather than each cluster having an associated range of intent index values, each cluster may be associated with a single intent index value. For example, a first cluster may be associated with an intent index value of 0.1, a second cluster may be associated with an intent index value of 0.18, a third cluster may be associated with an intent index value of 0.22, and the like. In such an example, the search queries mapped to a given cluster will all have the same intent index value.

The intent index value may be determined based on an algorithm or ratio. For example, the intent index value for a given cluster may be determined as a ratio of the number of search queries using a certain search filter as compared to the total number of historical queries. In some examples, the intent index value may be determined based on the total number of historical queries allocated to that cluster. For example, if a given cluster has ten million historical search queries allocated to that cluster, the intent index value for that given cluster would be the number of search queries using a certain filter, e.g., images, videos, text, news, etc., as compared to ten million historical search queries.

According to some examples, the intent index values of the clusters may dynamically change as the number of historical queries increases. For example, as the system receives additional queries and maps the queries to a given cluster, the system may update the intent index value of the cluster. In some examples, the queries may be allocated to ensure that the number of queries mapped to each cluster is substantially equal. As the historical search queries are mapped to a given cluster, the intent index value associated with the cluster may increase or decrease based on the filters associated with the historical search.

The intent index value and/or intent index value ranges of the clusters may be configured such that each cluster has substantially the same number of historical search queries within the cluster. As shown in FIG. 4, a first cluster may range from 0-0.09, a second cluster may range from 0.1-0.17, a third cluster may range from 0.18-0.29, and the like.

According to some examples, the intent index value and/or range for a given cluster and the intent index value for a given search query may be determined using substantially the same approach. For example, the intent index value and/or range for a given cluster may be determined using an algorithm, such as a ratio or AI model and the intent index value for a given search query may be determined using the same algorithm.

The intent index value and/or intent index value ranges may provide an indication as to the query intent for a given search query. For example, if the intent index value is for whether the search query has the query intent to receive images as responsive content, the cluster having greater intent index values is more likely to correspond to the query intent as compared to the cluster having a lower intent index value. While the example shown indicates that a higher intent index value and, therefore, a high cluster may indicate the query intent more likely corresponds to a given format and a lower intent index value and, therefore, a lower cluster may indicate the query intent less likely corresponds to the given format, the opposite could be true. For example, a higher intent index value and, therefore, a high cluster may indicate the query intent less likely corresponds to a given format and a lower intent index value and, therefore, a lower cluster may indicate the query intent more likely corresponds to the given format.

According to some examples, in block 234, the cluster may be used to identify content responsive to the search query. The cluster may include content that is responsive to the search query. In some examples, the content within the cluster may be in the format corresponding to the format indicated by the query intent. For example, if the intent of the user submitting the search query, e.g., the query intent, was to receive images responsive to the search query, the responsive content may include one or more images. In examples where the query intent was to receive text based content, the responsive content may include text.

According to some examples, the cluster may correspond to a weight or signal provided as input into an AI model, such as the content identification model 550. The weight may correspond to how likely or not the query intent is for content having a particular format. The content identification model 550 may be modified, or trained, to identify content responsive to the search query having a format corresponding to the query intent.

Referring to FIG. 5B, in examples where the intent index value 558 is mapped to a cluster 560, the cluster 560 and/or the intent index value 558 may be provided as input to the content identification model 550. The content identification model 550 may use the intent index value 558 and/or cluster 560 to identify content responsive to the search query in a format associated with the intent index value 558 and/or cluster 560. The content identification model 550 may provide, as output, the responsive content 536.

Referring back to FIG. 2, in some examples, in block 236 the server 224 may alter the format of the responsive content. For example, the intent index value and/or the cluster the intent index value is allocated to may be provided as a signal into an AI model trained to alter the visual format of the content and/or digital component. For example, visual characteristics, such as size, shape, color, etc., may be associated with the content. The AI may be trained to predict whether to alter the visual characteristics of the content based on the intent index value and/or the cluster. For example, if the intent index value and/or the cluster indicates that the intent of the search query was to receive images responsive to the search query, the AI may be trained to alter the visual format of the content such that the content, e.g., an image in this example, is larger as compared to if the intent of the search was to receive text.

The AI model may be, for example, the content identification model 550. In some examples, the AI model may be a different AI model, or an engine within an AI model, or the like. In examples there the AI model is the content identification model 550, the intent index value and/or the cluster the intent index value is allocated to may be used as a signal to alter the format of the responsive content.

In some examples, in block 238, the server 225 may predict a click through rate associated with the responsive content. For example, the intent index value and/or the cluster the intent index value is allocated to may be provided as a signal into an AI model, trained to provide, as output, predicted click through rates (CTR). Predicted CTRs may indicate how likely a user is to click on the content provided in response to the search query. According to some examples, a higher intent index value and/or cluster may correspond to a higher click through rate. For example, if the intent index value and/or cluster is associated with a high likelihood the query intent is for content in the format of images, a higher intent index value and/or cluster may correspond to a higher predicted CTR.

The intent index value and/or the cluster may be provided as an input signal to the AI model to adjust the predicted CTR. For example, if the discrete cluster has a range of intent indexes above a threshold, the predicted CTR may be up-regulated whereas if the discrete cluster has a range of intent indexes below a threshold, the predicted CTR may be down-regulated. Up-regulating the predicted CTR may include, for example, weighting the predicted CTR such that the predicted CTR for content responsive to the search query is higher, or more likely. In contrast, down-regulating the predicted CTR may include weighting the predicted CTR such that the predicted CTR for content responsive to the search query is lower, or less likely.

According to some examples, the threshold may be automatically determined and/or adjusted by the AI model predicting the CTR. For example, the model may include a feedback loop to determine the weight to provide the input signal. The input signal may be, for example, the intent index value and/or the cluster. The feedback loop may include updating the AI model based on observed data, such as the outputs of the AI model. For example, based on the observed data and/or feedback, the AI model may optimize the weight to apply to the signal. The feedback may be user feedback, model feedback, or a combination of feedback.

The AI model predicting the CTR may be, for example, a CTR prediction model. The CTR prediction model may be configured to receive training data for use in predicting the CTR of content. The CTR prediction model may receive and/or process the training data in method similar to those described above with respect to the intent index model 330. The CTR prediction model may provide, as output, one or more results related to the prediction. The results of the CTR prediction model may be generated as output data.

The training data can correspond to an AI task for predicting the CTR of content. The inference data may include, for example, training labels associated with clicks. In some examples, the inference data may be signals generated from search queries as features. From the training data and/or inference data, the CTR prediction model can be trained to predict the CTR for responsive content. According to some examples, the CTR prediction model may weigh the predicted CTR based on the intent index value and/or cluster. In some examples, the intent index value and/or cluster may be provided as a signal into the CTR prediction model such that the CTR prediction model automatically up-regulates or down-regulators the CTR prediction for responsive content.

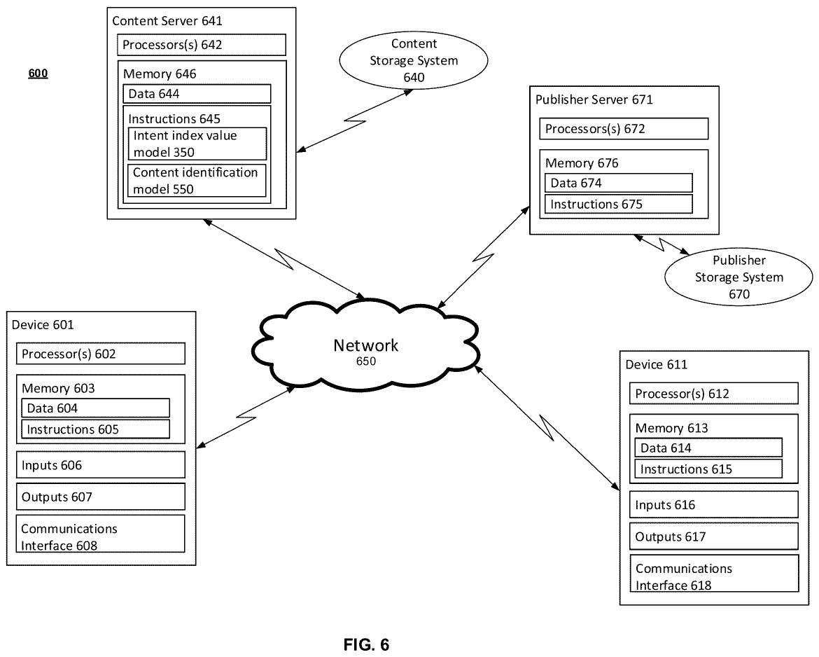

FIG. 6 illustrates an example system 600 in which the features described above and herein may be implemented. In this example, system 600 includes devices 601, 611, digital component server 641, content storage system 640, publisher server 671, and network 650. For purposes of clarity, devices 601, 611 will be described with respect to device 601. However, it should be understood that device 611 may include the same or similar components and may function in substantially the same way.

According to some examples, publisher server 671 may receive a search query, via network 650, submitted from a user, via device 601. In some examples, the search query may be received by server 641. The publisher server 671 may transmit a request to content server 641 for content responsive to the search query. The content server 641 may determine an intent index value based on the search query. The intent index value may be determined as a ratio and/or using the intent index value model 350. In some examples, the intent index value may be mapped to a cluster such that the cluster is used to identify content responsive to the search query. In another example, the intent index value and/or the cluster may be provided as input into the content identification model 550 to identify content responsive to the search query in a format corresponding to the query intent. According to some examples, the content may be stored in the content storage system 640. The content server 641 may transmit the responsive content to the publisher server 671 and/or device 601 to be provided for display in output 607 of device 601. While content server 641 and publisher server 671 are shown as separate servers, content server 641 and publisher server 671 may be part of the same server.

FIG. 6 illustrates an example system in which the features described above and herein may be implemented. It should not be considered as limiting the scope of the disclosure or usefulness of the features described herein. In this example, system 600 includes devices 601, 611, content server 641, content storage system 640, publisher server 671, publisher storage system 670, and network 650. For purposes of clarity, devices 601, 611 will be described with respect to device 601. However, it should be understood that device 611 may include the same or similar components and may function in substantially the same way.

Device 601 may be a user device. Device 601 may include one or more processors 602, memory 603, data 604 and instructions 605. Device 601 may also include inputs 606, outputs 607, and a communications interface 608. The devices 601 may be, for example, a smart phone, tablet, laptop, smart watch, AR/VR headset, smart helmet, home assistant, etc.

Memory 603 of device 601 may store information that is accessible by processor 602. Memory 603 may also include data that can be retrieved, manipulated or stored by the processor 602. The memory 603 may be of any non-transitory type capable of storing information accessible by the processor 602, including a non-transitory computer-readable medium, or other medium that stores data that may be read with the aid of an electronic device, such as a hard-drive, memory card, read-only memory (ROM), random access memory (RAM), optical disks, as well as other write-capable and read-only memories. Memory 603 may store information that is accessible by the processors 602, including instructions 605 that may be executed by processors 602, and data 604.

Data 604 may be retrieved, stored or modified by processors 602 in accordance with instructions 605. For instance, although the present disclosure is not limited by a particular data structure, the data 604 may be stored in computer registers, in a relational database as a table having a plurality of different fields and records, XML documents, or flat files. The data 604 may also be formatted in a computer-readable format such as, but not limited to, binary values, ASCII or Unicode. By further way of example only, the data 604 may comprise information sufficient to identify the relevant information, such as numbers, descriptive text, proprietary codes, pointers, references to data stored in other memories (including other network locations) or information that is used by a function to calculate the relevant data.

The instructions 605 can be any set of instructions to be executed directly, such as machine code, or indirectly, such as scripts, by the processor 602. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 602 may include any conventional processors, such as a commercially available CPU or microprocessor. Alternatively, the processor can be a dedicated component such as an ASIC or other hardware-based processor. Although not necessary, device 601 may include specialized hardware components to perform specific computing functions faster or more efficiently.

Although FIG. 6 functionally illustrates the processor, memory, and other elements of device 601 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of device 601. Accordingly, references to a processor or device will be understood to include references to a collection of processors or devices or memories that may or may not operate in parallel.

The inputs 606 may be, for example, a mouse, keyboard, touchscreen, microphone, camera, image capturing device, or any other type of input. The inputs may be configured to receive a search query.

Output 607 may be a display, such as a monitor having a screen, a touchscreen, a projector, or a television. The display 607 of the device 601 may electronically display information to a user via a graphical user interface (GUI) or other types of user interfaces. For example, display 607 may electronically display the content responsive to the search query in the format corresponding to the query intent.

The devices 601 can be at various nodes of a network 650 and capable of directly and indirectly communicating with other nodes of network 650. Although two devices are depicted in FIG. 6, it should be appreciated that a typical system can include one or more computing devices, with each computing device being at a different node of network 650. The network 650 and intervening nodes described herein can be interconnected using various protocols and systems, such that the network can be part of the Internet, World Wide Web, specific intranets, wide area networks, or local networks. The network 650 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 600 may include one or more server computing devices, such as content server 641 and publisher server 671. The server computing devices may be, for example, a load balanced server farm, that exchanges information with different nodes of a network for the purpose of receiving, processing and transmitting the data to and from other computing devices. For instance, ad server 641 and publisher server 671 may be a web server that is capable of communicating with the device 601 via the network 650. In addition, content server 641 and publisher server 671 may use network 650 to transmit and present information to a user of device 601. Content server 641 and publisher server 671 may include one or more processors 642, 672, memory 646, 676, data 644, 674, instructions 645, 675, etc. These components operate in the same or similar fashion as those described above with respect to device 601.

Content server 641 may manage content, such as digital components, and provide various services to the advertisers, publishers, and devices 601. According to some examples, content server 641 may receive content submissions from one or more content providers, such as merchants, advertisers, brands, or the like. The content submissions may include the digital component and data associated with the digital component. The data associated with the digital component may include, for example, the content provider, an identification of a brand or product within the digital component, or the like. The content submissions may be stored in the memory 646 of content server 641 and/or in content storage system 640.

According to some examples, publisher server 671 may provide content for output on a first user device. For example, publisher server 671 may receive content from content server 641. For example, publisher server 671 may transmit a request for responsive content to content server 641. Content server 641 may facilitate the identification of responsive content in the format corresponding to the query intent.

In some examples, publisher server may retrieve content from a publisher storage system 670 to provide for output to the first user device. The publisher server 671 may transmit a content page or other presentation, representation, or characterization of the content to the requesting device 601. According to some examples, the content page may include, for example, content responsive to the search query in a format corresponding to the query intent.

Device 601 may present in a viewer, such as a browser, mobile application, or other content display system, the responsive content in the format corresponding to the query intent provided by the content server 641. The responsive content may be provided for display on device 601 in response to receiving a search query.

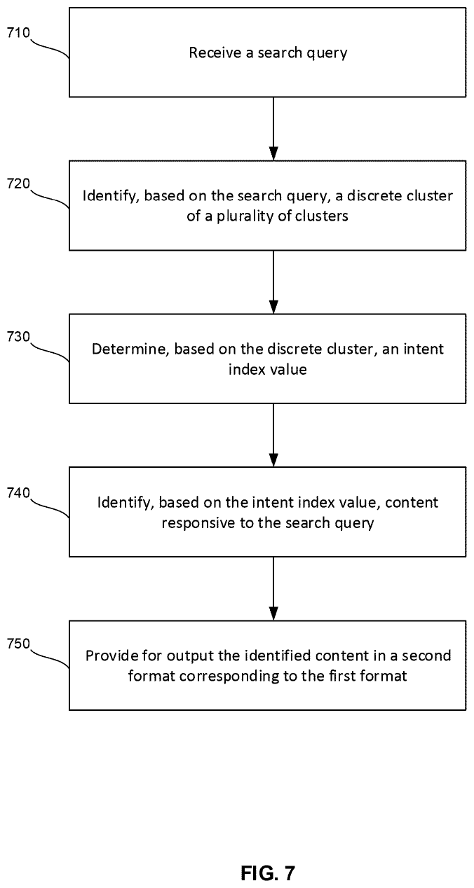

FIG. 7 illustrates an example method for providing content responsive to a search query in a format corresponding to the query intent. The following operations do not have to be performed in the precise order described below. Rather, various operations can be handled in a different order or simultaneously, and operations may be added or omitted.

In block 710, a search query may be received. For example, the search query may be received by a server, a publisher, or the like. As an example, the search query may be “dogs running through a field.” In block 720, a discrete cluster of a plurality of clusters may be identified based on the search query. Each cluster of the plurality of clusters may include content in a respective format. According to some examples, the discrete cluster may be identified by comparing at least one term within the search query to historical search queries associated with the plurality of clusters. The discrete cluster may be identified based on the query having historical search queries including at least one term. According to some examples, the historical search queries may include synonyms corresponding to the at least one term. In such an example, the discrete cluster may be identified bay having historical queries including synonyms of the at least one term of the search query.

According to some examples, each of the plurality of clusters may be equal in size based on a number of historical search queries. For example, each cluster may include, or correspond, to the substantially the same number of search queries.

In block 730, an intent index value may be determined based on the discrete cluster. The intent index value may provide an indication that the search query is for content in a first format. The first format may be, for example, images, videos, audio, text, or a combination of formats. As an example, the intent index value may provide an indication that the search query “dogs running through a field” is for content in the format of images.

For example, the cluster may be mapped to a range of intent index values inclusive of the determined intent index value. The ranges of the clusters may, in some examples, vary in size. For example, if the intent index value is a scale of zero to one, a first cluster may have an intent index value range of 0.01-0.13, while a second cluster may have an intent index value range of 0.14-0.19, and a third cluster may have an intent index value range of 0.20-0.38, and so on. In some examples, the clusters may be mapped to an intent index value, rather than a range of intent index values. The intent index value ranges and/or the intent index values of the clusters may be updated as additional search queries are performed.

The intent index value may be determined using an AI model, such as the intent index model 330. The AI model may be trained to determine the intent index value. According to some examples, the AI model may be a language model or a large language model.

Training the AI model may comprise associating labels with search queries. The labels may indicate a search filter associated with the search queries. The search filter may be, for example, an image filter, video filter, news filter, shopping filter, etc. Query level features may be provided as training data to the AI model. The query level features may comprise one or more of historical properties of the search queries, embeddings associated with the search queries, query string features, geographical features associated with the search queries, or language of the search queries. When executing the AI model, the search query may be provided as input into the AI model. When the AI model is executed, the AI model may determine the intent index value of the search query.

In some examples, the intent index values may be determined using a ratio. The ratio may be, for example, a ratio of a number of search queries for the first format to the total number of search queries for all formats.

In block 740, content responsive to the search query may be identified based on the discrete cluster. For example, the cluster the intent index value is mapped to may include content in the format corresponding to query intent. In examples where the query intent is for images, the intent index value may be mapped to a cluster having content, in the format of images, responsive to the search query. The content responsive to the search query may be identified from the content associated with the cluster.

According to some examples, the content responsive to the search query may be determined by executing an AI model, such as the content identification model 550. In some examples, the discrete cluster may be provided for input into the AI model. In another example, the intent index may be provided as input into the AI model in addition to the discrete cluster or as an alternative to providing the discrete cluster. The AI model may be trained to identify content responsive to the search query in the format corresponding to the first format. In some examples, the AI model may, additionally or alternatively, be trained to identify the format of the content. The format of the content may include one or more of a size and the format of the content.

In block 750, the responsive content may be provided for output in a format corresponding to the first format. The format may be, for example, one or more of image, video, text, or audio. For example, if the first format is images, the responsive content provided for output may output as an image. The content may include, for example, at least one digital component. The digital component may, in some examples, be an advertisement. In some examples, the content may be search results responsive to the search query. Additionally or alternatively, the content may be a combination of search results and digital components.

According to some examples, a click through rate (“CTR”) prediction may be adjusted. For example, one or more of the AI models discussed herein, or another AI model, may be trained to predict the CTR. The predicted CTR may be adjusted based on the discrete cluster the intent index value has been mapped to. For example, when the discrete cluster has a range of intent indexes above a threshold, the CTR prediction may be upregulated. In contrast, when the discrete cluster has a range of intent indexes below the threshold, the CTR prediction may be downregulated.

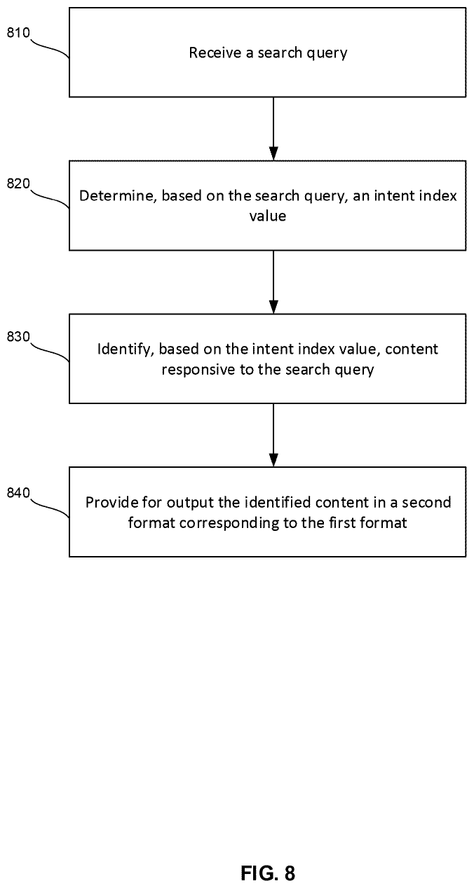

FIG. 8 illustrates another example method for providing content responsive to a search query in a format corresponding to the query intent. The following operations do not have to be performed in the precise order described below. Rather, various operations can be handled in a different order or simultaneously, and operations may be added or omitted. FIG. 8 is substantially similar to FIG. 7 but does not include the step of identifying a discrete cluster.

In block 810, a search query may be received.

In block 820, an intent index value may be determined based on the search query. The intent index value may be determined using an AI model, such as the intent index model 330. In some examples, the intent index values may be determined using a ratio.

In block 830, content responsive to the search query may be identified based on the intent index value. According to some examples, the content responsive to the search query may be determined by executing an AI model, such as the content identification model 550. For example, the intent index value may be provided as input into the AI model.

In block 850, the responsive content may be provided for output in a format corresponding to the first format.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as a TensorFlow framework, a Microsoft Cognitive Toolkit framework, an Apache Singa framework, or an Apache MXNet framework, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors, a search query;
determining, by the one or more processors, an intent index value, wherein the intent index value provides an indication that the search query is for content in a first format;
identifying, by the one or more processors based the intent index value, content responsive to the search query; and
providing for output, by the one or more processors, the identified content in a second format corresponding to the first format.

2. The method of claim 51, wherein when identifying the discrete cluster, the method further comprises:
comparing, by the one or more processors, at least one term within the search query to historical search queries associated with the plurality of clusters; and
identifying, by the one or more processors, the discrete cluster having one or more historical search queries including the at least one term.

3. The method of claim 51, wherein:
each of the plurality of clusters are equal in size based on a number of historical queries, and
each respective cluster corresponds to a range of intent index values or the intent index value.

4. The method of claim 1, wherein the content includes at least one digital component.

5. The method of claim 1, wherein when determining the intent index value, the method further comprises:
providing, by the one or more processors, the search query as input into artificial intelligence (“AI”) model; and
determining, by the one or more processors executing the AI model, the intent index value.

6. The method of claim 5, further comprising training the AI model, wherein training the AI model comprises:
associating labels with search queries, wherein the labels indicate a search filter associated with the search queries; and
providing, as training data, one or more query level features, the query level features comprising one or more of historical properties of the search queries, embeddings associated with the search queries, query string features, geographical features associated with the search queries, or language of the search queries.

7. The method of claim 5, wherein the AI model is a language model (LM) or a large language model (LLM).

8. The method of claim 1, wherein determining the intent index value comprises determining a ratio of a number of search queries for the first format to a total number of search queries for all formats.

9. The method of claim 1, wherein:
the first format includes one or more of image, video, text, or audio, and
the second format includes one or more of image, video, text, or audio.

10. The method of claim 2, further comprising providing as input, by the one or more processors, the respective cluster to an artificial intelligence (AI) model.

11. The method of claim 10, further comprising determining, by one or more processors executing the AI model, the second format of the content, wherein the second format of the content includes one or more of a size and the format of the content.

12. The method of claim 10, further comprising adjusting, by the one or more processors executing the AI model, a click through rate (CTR) prediction.

13. The method of claim 12, wherein adjusting the CTR prediction includes:
up-regulating the CTR prediction when the identified discrete cluster has a range of intent indexes above a threshold, and
down-regulating the CTR prediction when the identified discrete cluster has a range of intent indexes below the threshold.

14. A system, comprising:
one or more processors, the one or more processors configured to:
receive a search query;
determine an intent index value, wherein the intent index value provides an indication that the search query is for content in a first format;
identify, based the intent index value, content responsive to the search query; and
provide for output the identified content in a second format corresponding to the first format.

15. The system of claim 53, wherein when identifying the discrete cluster, the one or more processors are further configured to:
compare at least one term within the search query to historical search queries associated with the plurality of clusters; and
identify the discrete cluster having one or more historical search queries including the at least one term.

16. The system of claim 53, wherein:
each of the plurality of clusters are equal in size based on a number of historical queries,
each respective cluster corresponds to a range of intent index values, and
the identified discrete cluster has the range of intent index values inclusive of the determined intent index values.

17. (canceled)

18. The system of claim 25, wherein when determining the intent index value, the one or more processors are further configured to:
provide processors, the search query as input into artificial intelligence (“AI”) model; and
determine, by executing the AI model, the intent index value.

19. The system of claim 18, wherein the one or more processors are further configured to train AI model, wherein training the AI model comprises:
associating labels with search queries, wherein the labels indicate a search filter associated with the search queries; and
providing, as training data, one or more query level features, the one or more query level features comprising one or more of historical properties of the search queries, embeddings associated with the search queries, query string features, geographical features associated with the search queries, or language of the search queries.

20. (canceled)

21. The system of claim 14, wherein determining the intent index value comprises determining a ratio of a number of search queries for the first format to a total number of search queries for all formats.

22. The system of claim 14, wherein:
the first format includes one or more of image, video, text, or audio, and
the second format includes one or more of image, video, text, or audio.

23. The system of claim 53, wherein the one or more processors are further configured to provide as input the respective cluster to an artificial intelligence (AI) model.

24. The system of claim 23, wherein the one or more processors are further configured to determine, by executing the AI model, the second format of the content, wherein the second format of the content includes one or more of a size and the format of the content.

25. The system of claim 23, wherein the one or more processors are further configured to adjust, by executing the AI model, a click through rate (CTR) prediction, and
wherein adjusting the CTR prediction includes:
up-regulating the CTR prediction when the identified discrete cluster has a range of intent indexes above a threshold, and
down-regulating the CTR prediction when the identified discrete cluster has a range of intent indexes below the threshold.

26. (canceled)

27. One or more non-transitory computer readable media encoding instructions that, when executed by one or more processors, cause the one or more processors to perform operations comprising:
receiving a search query;
determining an intent index value, wherein the intent index value provides an indication that the search query is for content in a first format;
identifying, based the intent index value, content responsive to the search query; and
providing for output the identified content in a second format corresponding to the first format.

28. The non-transitory computer readable media of claim 55, wherein when identifying the discrete cluster, the operations further comprises:
comparing at least one term within the search query to historical search queries associated with the plurality of clusters; and
identifying the discrete cluster having one or more historical search queries including the at least one term.

29. The non-transitory computer readable media of claim 55, wherein:
each of the plurality of clusters are equal in size based on a number of historical queries,
each respective cluster corresponds to a range of intent index values, and
the identified discrete cluster has the range of intent index values inclusive of the determined intent index values.

30. (canceled)

31. The non-transitory computer readable media of claim 27, wherein when determining the intent index value, the operations further comprise:
providing processors, the search query as input into artificial intelligence (“AI”) model; and
determining, by executing the AI model, the intent index value.

32. The non-transitory computer readable media of claim 31, wherein the operations further comprise training the AI model, wherein training the AI model comprises:
associating labels with search queries, wherein the labels indicate a search filter associated with the search queries; and
providing, as training data, one or more query level features, the one or more query level features comprising one or more of historical properties of the search queries, embeddings associated with the search queries, query string features, geographical features associated with the search queries, or language of the search queries.

33. (canceled)

34. The non-transitory computer readable media of claim 27, wherein determining the intent index value comprises determining a ratio of a number of search queries for the first format to a total number of search queries for all formats.

35. The non-transitory computer readable media of claim 27, wherein:
the first format includes one or more of image, video, text, or audio, and
the second format includes one or more of image, video, text, or audio.

36. The non-transitory computer readable media of claim 27, wherein the operations further comprise:
providing as input the respective cluster to an artificial intelligence (AI) model; and
determining, by executing the AI model, the second format of the content, wherein the second format of the content includes one or more of a size and the format of the content.

37. (canceled)

38. The non-transitory computer readable media of claim 36, wherein the operations further comprise adjusting, by executing the AI model, a click through rate (CTR) prediction, and
wherein adjusting the CTR prediction includes:
up-regulating the CTR prediction when the identified discrete cluster has a range of intent indexes above a threshold, and
down-regulating the CTR prediction when the identified discrete cluster has a range of intent indexes below the threshold.

39-50. (canceled)

51. The method of claim 1, further comprising identifying, by the one or more processors based on the search query, a discrete cluster of a plurality of clusters, wherein each cluster of the plurality of clusters includes content in a respective format,
wherein determining the intent index value is based on the discrete cluster.

52. The method of claim 1, further comprising:
providing as input, by the one or more processors, the intent index value to an artificial intelligence (AI) model; and
determining, by one or more processors executing the AI model, the second format of the content, wherein the second format of the content includes one or more of a size and format of the content.

53. The system of claim 14, wherein the one or more processors are further configured to identify, based on the search query, a discrete cluster of a plurality of clusters, wherein each cluster of the plurality of clusters includes content in a respective format,
wherein determining the intent index value is based on the discrete cluster.

54. The system of claim 14, wherein the one or more processors are further configured to:
provide as input the intent index value to an artificial intelligence (AI) model; and
determine, by executing the AI model, the second format of the content, wherein the second format of the content includes one or more of a size and format of the content.

55. The non-transitory computer readable media of claim 27, wherein the operations further comprise identifying, based on the search query, a discrete cluster of a plurality of clusters, wherein each cluster of the plurality of clusters includes content in a respective format,
wherein determining the intent index value is based on the discrete cluster.
